(19) United States
(12) Patent Application Publication
(10) Pub. No.: US 2004/0121736 A1
(43) Pub. Date: Jun. 24, 2004

(54) Device for transmitting digital signals among mobile units with analog filtering

(76) Inventors: Harry Schilling, Eichstatt (DE); Nils Krumme, Feldafing (DE); Georg Lohr, Eichenau (DE)

Correspondence Address: CONLEY ROSE, P.C., P.O. BOX 684908, AUSTIN, TX, 78768, US

(21) Appl. No.: 10/674,876

(22) Filed: Sep. 29, 2003

(30) Foreign Application Priority Data
Sep. 27, 2002 (DE) 10245505.8

(51) Int. Cl. H04B 1/44

(52) U.S. Cl. 455/78

(57) ABSTRACT

A device for transmitting digital signals between two units mobile relative to each other, in particular via non-contacting rotary joints, comprises a coding means on a transmitter side along a signal transmission path, for matching a coding of the digital signals to transmission characteristics of the transmission path so as to achieve a predetermined spectral distribution of a signal. An optional decoder means on a receiver side regenerates original signals so that the coding will be hidden, but a substantially more reliable transmission is achieved.

### FIELD OF THE INVENTION

The present invention relates to a device for the transmission of digital signals among a plurality of units mobile relative to each other.

For the sake of clarity, in the present document, the transmission between units mobile relative to each other, on the one hand, is not distinguished from the transmission between a stationary unit and units mobile relative to the first unit, on the other hand, because this is only a question of local relationship and does not take any influence on the mode of operation of the invention. Equally, a distinction is not made between the transmission of signals and energy because the mechanisms of operation are the same in this respect.

### PRIOR Art

In units mobile along a linear path, such as crane and conveyor installations, as well as in rotary units such as radar systems and also computer tomographs, it is necessary to transmit electrical signals or energy, respectively, between units mobile relative to each other. To this end, mostly a conductor array is provided in the first unit and corresponding intercepting means are provided in the second unit. The term “conductor arrays” as used in the description given below refers to any forms whatsoever of conductor arrays conceivable, which are suitable for conducting electrical signals. This refers also to the known contacting sliding paths or slip rings, respectively.

A suitable device is described in the laid-open German Patent Application DE 44 12 958 A1. There, the signal to be transmitted is supplied into a strip conductor of the first unit that is arranged along the path of the movement of the units mobile relative to each other. The signal is tapped from the second unit by means of capacitive or inductive coupling.

The coupling factor of the signal between the two units is substantially a function of the distance of the two units from each other. Particularly in transmission systems with three-dimensional extension and especially in the event of high speeds of movement, the distances between the mobile units cannot be determined with an optional precision, which is due to the mechanical tolerances. As the position of the two units relative to each other, the speed (e.g. caused by vibrations) and other influential parameters vary, the coupling factor frequently varies therefore, too. At the same time, the signal amplitude at the receiver input varies as well. This results in variations in the signal in receivers presenting the conventional design, which are noticeable, for instance, in the form of an increased jittering or even bit errors. Moreover, variations of the noise immunity occur likewise as a result.

The device disclosed in DE 197 00 110 A1 leads to an improvement of the transmission characteristics, which device presents a conductor array with filter features instead of a strip line. On principle, however, the problems remain as they are.

U.S. Pat. No. 6,433,631 B2 discloses a device for feedback control of the input level at the receiver. To this end, the signal amplitude is measured downstream of a pre-amplifier whilst an attenuator element is controlled in correspondence with this signal amplitude, which is provided ahead of the pre-amplifier. The disadvantage of this system resides in the aspect that it can exclusively make a signal available to the receiver, which presents a constant amplitude.

The disadvantage of the devices according to prior art resides in a still insufficient noise immunity. Even though the levels of the transmitted signal can be increased on the line in order to improve the noise immunity the undesirable radiation of high-frequency signals increases as well. As a matter of fact, a reduction of the level of the transmitted signal reduces the radiation but the immunity to stray-in interference from the outside is reduced as well.

### BRIEF DESCRIPTIONS OF THE INVENTION

The present invention is based on the problem of designing a device for the transmission of electrical signals, which avoids the aforementioned disadvantages and presents in particular a high noise immunity and hence a high quality of signal transmission.

In accordance with the present invention, this problem is solved with the means defined in the independent claims. Expedient improvements of the invention are the subject matters of the dependent further claims.

An inventive device serves to transmit digital signals between at least two units mobile relative to each other. It is, of course, possible to arrange one or more units on each side of the movement. For a simplified representation, here reference is made exclusively to a second unit that is mobile relative to a first unit.

A data source (1) for generating a serial data stream such as a parallel-to-serial converter according to prior art is associated with the first unit. Moreover, a transmitter (2) is provided that generates electrical signals from the serial data stream of the data source for the transmission to a transmitter conductor array (3). A receiving antenna (4) for intercepting electrical signals in the near field of the transmitter conductor array is associated with the second unit. The electrical signals of the receiving antenna are supplied via a receiver (5) to a data sink (6) for subsequent processing of the signals.

In accordance with the invention, now at least one filter is provided for the transmitter (2) or the receiver (5), respectively, for adaptation to the transmission characteristics of the data transmission path between the transmitter and the receiver. This data transmission path comprises all the components that are located along the path of the electrical signal between the transmitter and the receiver. This includes the transmitter conductor structure (3) and the receiving antenna (4). For instance, frequency-dependent amplitude and phase responses can be corrected in particular on the side of the transmitter or the receiver, respectively. Such filters may serve to reduce also external noise.

According to the present invention, the filtering of the data stream involves a conversion of the spectral characteristics of the data stream. In this manner, filtering is carried out in such a way that the power of the signal is optionally increased or reduced within predetermined spectral ranges. As a result of an adaptation of the spectral characteristics of the signal it is possible to match the transmission quality to the frequency response of the remaining part of the transmission path as well as to existing disturbing units or noise-sensitive components, respectively.

When the data transmission path between the transmitter and the receiver presents a particularly strong attenuation, for instance within one or several known frequency ranges, it is not expediently possible to design the filtering function in such a way that this frequency range will not be employed for transmission. In the opposite case, when frequency ranges of a particularly low attenuation are present, it is possible to envisage appropriate coding in order to set a maximum within these frequency ranges.

When external disturbing units are present that impair the transmission of the signals the filtering function is expediently carried out in such a manner that these frequency ranges are optionally excepted. As an alternative, it is possible to emit a particularly high amplitude in these frequency ranges, too.

When particularly noise-sensitive components are present externally of the data transmission path the filtering process may serve to adapt the spectrum of the transmitted signal in such a way that only low signal levels are emitted within the frequency ranges of high noise sensitivity.

According to a further embodiment of the invention, the filtering function can be dynamically adjusted so that it may adapt itself expediently to variations caused by the movement. To this end, a controller is expediently provided that comprises, for example, a micro controller or a plain feedback control circuit including means for detecting the actual operating state and establishing a corresponding setting of the filter parameters to the filters.

In another advantageous embodiment, the device is a self-learning or adaptive design. This means that it adapts itself dynamically, in particular during the movement, to the conditions of operation. This may be realized, for instance, by way of detection of certain operating parameters such as the bit error ratio, the signal amplitude, etc. and by the subsequent setting of filter parameters on the filters. In this case, it is particularly expedient to employ a controller of the fuzzy-logic type. Particularly in the case of rotary movements, specifically at a constant speed, it is advantageous to store the transmission function by the rotation and to set the filters as a function of the time or the position, respectively. This is also possible, of course, in the case of linear movements provided that information is available relative to the position.

### DESCRIPTION OF THE DRAWINGS

In the following, the invention will be described by exemplary embodiments, without any limitation of the inventive idea, with reference to the drawings.

FIG. 1 illustrates a particularly expedient embodiment of an inventive device in a schematic form.

FIG. 1 is a general schematic view of an inventive device. The data of a data source (1) is transmitted via a first filter (7) and a linear transmitter (2) to a transmitter conductor array (3). The transmitter conductor array is disposed along the path of the movement that is roughly indicated by the directional arrow (9) and passes on the signals fed by the transmitter. A receiving antenna (4) permits the tapping of the signals of the near field of the transmitter conductor structure. The signals tapped by the antenna are passed on via a linear receiver (5) and a second filter (8) to the data sink (6). When a transmitter is used instead of the linear transmitter, which presents at least one digital input, optionally also a digital final stage, the filter must be disposed between the transmitter (2) and the transmitter conductor structure. It is possible to provide further filters in the transmitter as such or even between the transmitter (2) and the transmitter conductor array, independently of a first filter (7) between data sources (1) and transmitters (2). It is likewise possible to provide filters also on the second unit between the receiving antenna (4) and the receiver (5) or in the receiver (5) directly.

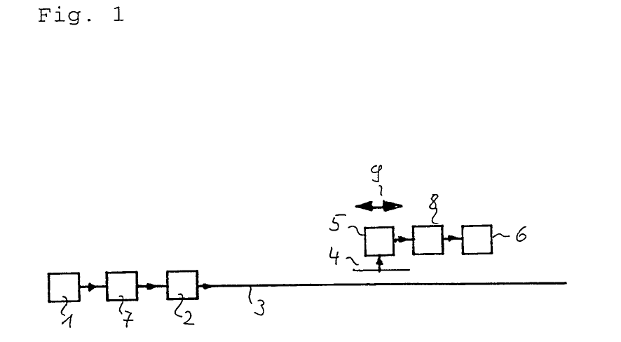

List of Reference numerals

1 data source

2 transmitter

3 transmitter conductor array

4 receiving antenna

5 receiver

6 data sink

7 first filter

8 second filter

9 directional arrow indicating the direction of movement

1. Device for wideband transmission of digital signals between at least one first unit and at least one second unit mobile along a predetermined path relative to said first unit, in particular via non-contacting rotary joints, said first unit comprising:
a data source for generating a serial data stream;
a transmitter for generating electrical signals from said serial data stream from said data source;
a transmitter conductor array for conducting said electrical signals generated by said transmitter;
and said second unit comprising:
a receiving antenna for tapping electrical signals in the near field of said transmitter conductor array;
a receiver for receiving the signals tapped by said receiving antenna;
a data sink for subsequent processing of the signals received by said receiver;
characterized in that at least one filter is provided, optionally assigned to said transmitter or said receiver, for adaptation to transmission characteristics of a data transmission path between said transmitter and said receiver.

2. Device according to claim 1, characterized in that said filter can be dynamically adjusted.

3. Device according to claim 1, characterized in that a micro controller is provided for controlling and diagnosing the device.

4. Device according to claim 1, characterized in that the device is self-learning and dynamically adapts itself to respective conditions of operation.
